(19) United States
(12) Patent Application Publication
(10) Pub. No.: US 2020/0004189 A1
(43) Pub. Date: Jan. 2, 2020

(54) IMAGE FORMATION DEVICE, IMAGE FORMATION METHOD, AND IMAGE FORMATION PROGRAM

(71) Applicant: KONICA MINOLTA, INC., Tokyo (JP)

(72) Inventor: Yushi Komaki, Toyokawa-shi (JP)

(73) Assignee: KONICA MINOLTA, INC., Tokyo (JP)

(21) Appl. No.: 16/439,898

(22) Filed: Jun. 13, 2019

(30) Foreign Application Priority Data
Jul. 2, 2018 (JP) 2018-126293

(51) Int. Cl. G03G 15/00

(52) U.S. Cl. CPC G03G 15/6508

(57) ABSTRACT

An image formation device includes: a plurality of containers that contains a recording medium; an image former that forms an image on the recording medium; and a hardware processor that determines the container that contains the recording medium on which an image is formed by the image former as a target container from among the plurality of containers, wherein the hardware processor determines a priority container that finally contains a recording medium among the plurality of containers as the target container.

The entire disclosure of Japanese patent Application No. 2018-126293, filed on Jul. 2, 2018, is incorporated herein by reference in its entirety.

### BACKGROUND

### Technological Field

The present invention relates to an image formation device, an image formation method, and an image formation program, and more particularly to an image formation device that can form an image on a recording medium of a different medium type, an image formation method that is executed by the image formation device, and an image formation program that causes a computer that controls the image formation device to execute the image formation method.

### Description of the Related Art

In an image formation device. e.g., an MFP (multi function peripheral), image formation conditions are specified according to a size of paper, and an image is formed on the paper according to the image formation conditions. Paper is contained in a paper feed tray. Therefore, the size of paper is preset in a paper feed cassette in the MFP. The technology that facilitates this setting includes, for example, JP 2014-133656 A. JP 2014-133656 A describes an image formation device including: an inputter that specifies a type of paper used for image formation; a paper cassette that contains paper and in which the type of paper to be contained is set; a storage that stores the type of paper, and a controller that determines whether the paper type set in the paper cassette is stored in the storage each time an image formation request is received, when it is determined that the paper type is stored in the storage, determines whether the type of paper specified by the inputter corresponds to the type of paper stored in the storage, when the type of paper specified by the inputter corresponds to the type of paper stored in the storage, gives an instruction of image formation, when the type of paper specified by the inputter does not correspond to the type of paper stored in the storage, does not give an instruction of image formation but notifies a user of results of the determination, meanwhile, when it is determined that the paper type is not stored in the storage in the determination as to whether the type of paper is stored in the storage performed each time the image formation request is made, gives an instruction of image formation, and determines whether to store the type of paper set in the paper cassette in the storage on the basis of results of the image formation.

Furthermore, a difference of medium type. e.g., basis weight of paper, affects image quality of an image formed on the paper. Therefore, the MFP can alter image formation conditions depending on the medium type of paper. Therefore, in a conventional MFP, in addition to the size of paper, a medium type is set in a paper feed cassette that contains paper. An image is formed on the paper under image formation conditions corresponding to the size of paper and the medium type contained in the paper feed cassette. As described above, the conventional MFP associates the size of paper to be used and the medium type in the paper feed cassette. Therefore, it is sufficient if a user that uses the MFP specifies a paper feed cassette in which paper to be used is contained. However, the user is required to specify a paper feed cassette after checking the size of paper and the medium type contained in a plurality of paper feed cassettes, and there is a problem that setting operations for causing the MFP to form an image are troublesome.

### SUMMARY

The present invention has been made to solve the aforementioned problem, and it is an object of the present invention to provide an image formation device that facilitates setting operations.

Another object of the present invention is to provide an image formation method that facilitates setting operations.

Yet another object of the present invention is to provide an image formation program that facilitates setting operations.

To achieve at least one of the abovementioned objects, according to an aspect of the present invention, an image formation device reflecting one aspect of the present invention comprises: a plurality of containers that contains a recording medium; an image former that forms an image on the recording medium; and a hardware processor that determines the container that contains the recording medium on which an image is formed by the image former as a target container from among the plurality of containers, wherein the hardware processor determines a priority container that finally contains a recording medium among the plurality of containers as the target container.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a perspective view illustrating an external appearance of an MFP according to a first embodiment;

FIG. 2 is a block diagram illustrating an overview of a hardware configuration of the MFP according to the first embodiment;

FIG. 3 is a schematic side view illustrating an internal configuration of a part of an image former and a paper feeder of the MFP of the first embodiment;

FIG. 4 is a block diagram illustrating an example of a function of a CPU of the MFP according to the first embodiment;

FIG. 5 is a view illustrating an example of an association table;

FIG. 6 is a view illustrating an example of a job priority table;

FIG. 7 is a view illustrating an example of a user priority table;

FIG. 8 is a flowchart illustrating an example of flow of an image formation processing according to the first embodiment;

FIG. 9 is a flowchart illustrating an example of flow of a candidate cassette determination processing according to the first embodiment;

FIG. 10 is a flowchart illustrating an example of flow of a specified cassette determination processing according to the first embodiment;

FIG. 11 is a flowchart illustrating an example of flow of a target cassette determination processing according to the first embodiment;

FIG. 12 is a flowchart illustrating an example of flow of an image formation control processing according to the first embodiment;

FIG. 13 is a block diagram illustrating an example of a function of a CPU of an MFP according to a second embodiment;

FIG. 14 is a flowchart illustrating an example of flow of an image formation processing according to the second embodiment;

FIG. 15 is a flowchart illustrating an example of flow of a target cassette determination processing according to the second embodiment; and

FIG. 16 is a flowchart illustrating an example of flow of an image formation control processing according to the second embodiment.

### DETAILED DESCRIPTION OF EMBODIMENTS

Hereinafter, one or more embodiments of the present invention will be described with reference to the drawings. However, the scope of the invention is not limited to the disclosed embodiments.

An image formation device according to embodiments of the present invention is described below with reference to the drawings. Like parts are designated with like reference numerals in the description below. Their names and functions are also the same. Therefore, their detailed descriptions will not be given. In addition, in the description below, an MFP is described as an example of the image formation device. Furthermore, the MFP described below is capable of forming an image on any recording media of different medium types as a recording medium on which an image is formed. In the present embodiment, paper is used as an example of the recording medium, and medium types include normal paper, high quality paper, and cardboard. Recording media of different medium types have different basis weights. Accordingly, the medium type of paper can be determined when the basis weight of the paper is detected. Note that the medium type can be detected from basis weight and, apart from basis weight, color or thickness of paper.

### First Embodiment

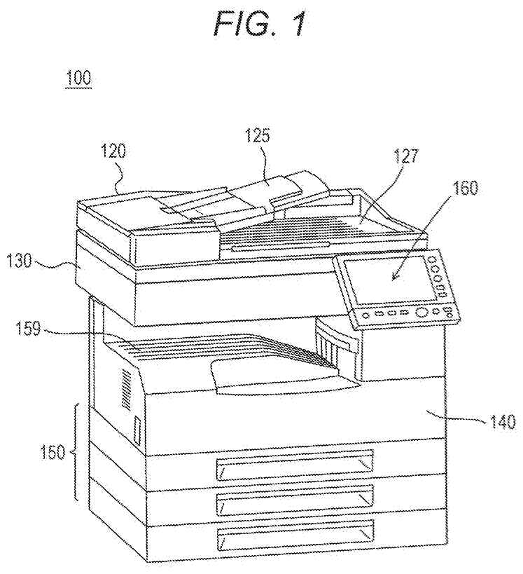

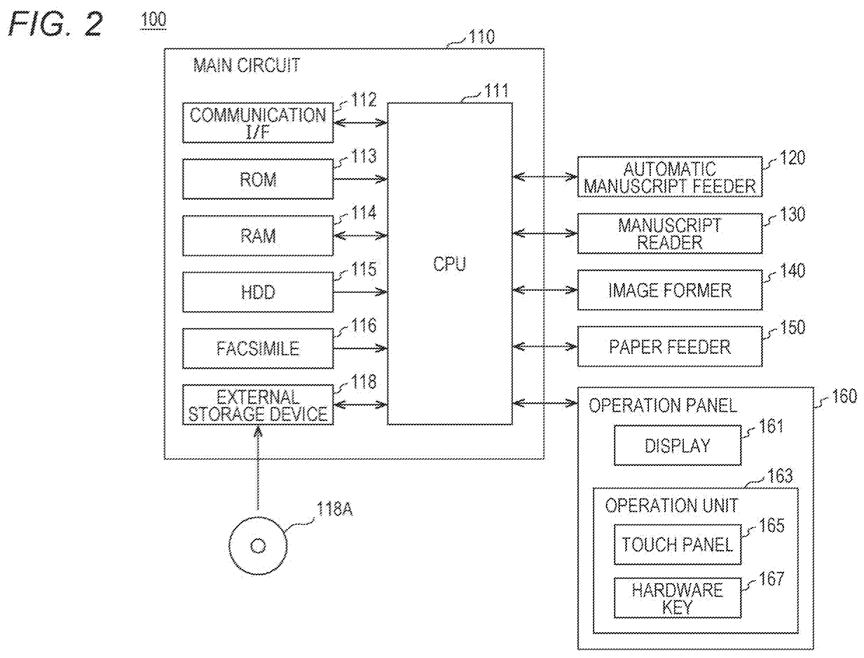

FIG. 1 is a perspective view illustrating an external appearance of an MFP according to a first embodiment. FIG. 2 is a block diagram illustrating an overview of a hardware configuration of the MFP according to the first embodiment. Referring to FIGS. 1 and 2, an MFP 100 is an example of an image formation device, includes a main circuit 110, a manuscript reader 130 for reading a manuscript, an automatic manuscript conveyer 120 for conveying a manuscript to the manuscript reader 130, an image former 140 for forming an image on paper on the basis of image data, a paper feeder 150 for feeding paper to the image former 140, and an operation panel 160, which is a user interface.

The automatic manuscript conveyer 120 automatically conveys a plurality of manuscripts set on a manuscript tray 125 to a manuscript read position of the manuscript reader 130 one by one, and discharges a manuscript whose image formed on the manuscript has been read by the manuscript reader 130 onto a manuscript discharge tray 127. The automatic manuscript conveyer 120 includes a manuscript detection sensor for detecting a manuscript placed on the manuscript tray 125.

The manuscript reader 130 has a reading surface having a rectangular shape for reading a manuscript. The reading surface is formed, for example, of platen glass. The automatic manuscript conveyer 120 is connected to a main body of the MFP 100 so as to be rotatable relative to an axis parallel to one side of the reading surface, and can be opened and closed. The manuscript reader 130 is arranged below the automatic manuscript conveyer 120, and the reading surface of the manuscript reader 130 is exposed with the automatic manuscript conveyer 120 being rotated and opened in an opened state. Therefore, the user can place a manuscript on the reading surface of the manuscript reader 130. The automatic manuscript conveyer 120 can be changed into states: an opened state in which the reading surface of the manuscript reader 130 is exposed and a closed state in which the reading surface is covered. The automatic manuscript conveyer 120 includes a state detection sensor that detects an opened state of the automatic manuscript conveyer 120.

The manuscript reader 130 includes a light source that emits light and a photoelectric conversion element that receives light, and scans an image formed on a manuscript placed on the reading surface. When a manuscript is placed on the reading region, the light emitted from the light source is reflected off the manuscript, and the reflected light forms an image with the photoelectric conversion element. When receiving the light reflected off the manuscript, the photoelectric conversion element generates image data obtained when the received light is converted into an electric signal. The manuscript reader 130 outputs the image data to the CPU 111 of the main circuit 110.

The paper feeder 150 conveys the paper contained in first to third paper feed cassettes and a manual insertion cassette described below to the image former 140. The paper feeder 150 detects information related to the paper conveyed to the image former 140 as medium information. In the present embodiment, the medium information is the basis weight of paper. Details of a configuration and an operation for detecting the medium information with the paper feeder 150 will be described below.

The image former 140 is controlled by the CPU 111 and forms an image by a well-known electrophotographic method. In the present embodiment, the image former 140 forms an image on the paper conveyed from the paper feeder 150 on the basis of the image data input from the CPU 111 and image formation conditions corresponding to the medium type of the paper. The paper on which the image is formed is discharged to the paper discharge tray 159. The image data output to the image former 140 by the CPU 111 includes not only image data input from the manuscript reader 130, but also image data, e.g., print data received from the outside.

The main circuit 110 includes the CPU (central processing unit) 111 that generally controls the MFP 100, a communication interface (I/F) 112, a ROM (read only memory) 113, a RAM (random access memory) 114, a hard disk drive (HDD) 115, which is a large capacity storage device, a facsimile 116, and an external storage device 118. The CPU 111 is connected to the automatic manuscript conveyer 120, the manuscript reader 130, the image former 140, the paper feeder 150, and the operation panel 160, and generally controls the MFP 100.

The ROM 113 stores a program that the CPU 111 executes, and data required for execution of the program. The RAM 114 is used as a working region for the CPU 111 to execute the program. In addition, the RAM 114 temporarily stores the image data that is sequentially delivered from the manuscript reader 130.

The operation panel 160 is provided on an upper part of the MFP 100. The operation panel 160 includes a display 161 and an operation unit 163. The display 161 is, for example, a liquid crystal display (LCD) device, and displays an instruction menu for a user or information related to acquired image data, or the like. Note that, instead of the LCD, any device that displays an image. e.g., an organic EL (electroluminescence) display, can be used.

The operation unit 163 includes a touch panel 165 and a hardware key 167. The touch panel 165 is of a capacitive type. Note that the touch panel 165 is not limited to a capacitive type, but may use other types including a resistive membrane type, a surface acoustic wave type, an infrared type, and an electromagnetic induction type.

The touch panel 165 is provided on the display 161 such that its detection surface is superimposed on an upper surface or a lower surface of the display 161. Here, the size of the detection surface of the touch panel 165 and the size of the display surface of the display 161 are the same. Therefore, a coordinate system of the display surface and a coordinate system of the detection surface are the same. The touch panel 165 detects the position instructed by the user on the display surface of the display 161 with the detection surface, and outputs the coordinate of the detected position to the CPU 111. Because the coordinate system of the display surface and the coordinate system of the detection surface are the same, the coordinate output by the touch panel 165 can be replaced with the coordinate of the display surface.

The hardware key 167 includes a plurality of hardware keys. The hardware key is, for example, a contact switch. The touch panel 165 detects the position instructed by the user within the display surface of the display 161. The user is often in an upright posture in operating the MFP 100. Therefore, the display surface of the display 161, the operation surface and the hardware key 167 of the touch panel 165 are arranged to face upward. This is for the user to be able to easily view the display surface of the display 161 and for the user to be able to easily give an instruction on the operation unit 163 with the finger.

The communication I/F 112 is an interface for connecting the MFP 100 to a network.

The communication I/F 112 communicates with another computer or a data processor connected to the network with a communication protocol. e.g., TCP (transmission control protocol) or FTP (file transfer protocol).

The network to which the communication I/F 112 is connected is a local area network (LAN), and a connection form may be wired or wireless. In addition, the network is not limited to LAN, but may be a wide area network (WAN), public switched telephone network (PSTN), the Internet. or the like.

The facsimile 116 is connected to the public switched telephone network (PSTN) and transmits facsimile data to the PSTN or receives facsimile data from the PSTN. The facsimile 116 stores the received facsimile data in the HDD 115, converts the data into print data that can be printed by the image former 140, and outputs the data to the image former 140. Thus, the image former 140 forms an image of the facsimile data received from the facsimile 116 on the paper. In addition, the facsimile 116 converts the data stored in the HDD 115 to the facsimile data and transmits the data to the facsimile device connected to the PSTN.

The external storage device 118 is controlled by the CPU 111, and to which a CD-ROM (compact disk read only memory) 118A or a semiconductor memory is attached.

In the present embodiment, description is given of an example in which the CPU 111 executes a program stored in the ROM 113. However, the CPU 111 may control the external storage device 118, read a program to be executed by the CPU 111 from the CD-ROM 118A, store the read program in the RAM 114, and execute the program.

Note that the recording medium for storing the program to be executed by the CPU 111 is not limited to the CD-ROM 118A, but may be a medium, e.g., a flexible disc, a cassette tape, optical disc (MO (magnetic optical disc)/MD (mini disc)/DVD (digital versatile disc)), an IC card, an optical card, a mask ROM, an EPROM (erasable programmable ROM). Furthermore, the program stored in the HDD 115 may be loaded into the RAM 114 and executed by the CPU 111 such that the CPU 111 downloads the program from the computer connected to the network and stores the program in the HDD 115 or the computer connected to the network writes the program into the HDD 115. The program herein is not limited to a program that can directly be executed by the CPU 111, but includes a source program compressed program, an encrypted program.

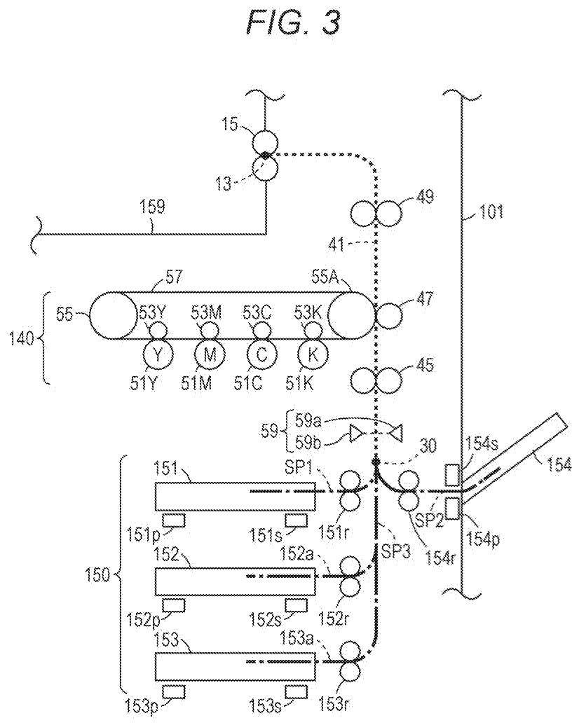

FIG. 3 is a schematic side view illustrating an internal configuration of a part of an image former and a paper feeder of the MFP of the first embodiment. Referring to FIG. 3, in the MFP 100, a main conveyance path 41 indicated by the bold dotted line is formed to basically extend in an up-and-down direction. The main conveyance path 41 is a path for guiding the paper conveyed from the paper feeder 150 to the paper discharge tray 159 through the image former 140. In the case of the main conveyance path 41 of the present example, a lower end portion 30 opposite to an upper end portion 13 that is positioned above the image former 140 constitutes a carry-in port for receiving the paper from the paper feeder 150. In addition, the upper end portion 13 of the main conveyance path 41 constitutes a discharge port for discharging the paper after image formation to the paper discharge tray 159. The upper end portion 13 of the main conveyance path 41 is provided with a paper discharge roller 15. The lower end portion 30 of the main conveyance path 41 is connected to a plurality of sub-conveyance paths SP1, SP2, SP3 of the paper feeder 150 to be described below. The paper conveyance direction is a direction of the paper discharge tray 159 from the paper feeder 150.

The paper feeder 150 includes three paper feed cassettes 151, 152, 153 and a manual insertion cassette 154 for containing the paper, which is a recording medium. The three paper feed cassettes 151, 152, 153 are arranged to be stacked in this order from above downward. Each of the three paper feed cassettes 151, 152, 153 is normally in a closed state, but becomes an opened state when drawn to the front side of the MFP 100 by the user. Each of the three paper feed cassettes 151, 152, 153 is positioned inside the main body of the MFP 100 in a closed state, and is opened on an upper side in an opened state. When each of the three paper feed cassettes 151, 152, 153 is in an opened state, the user can replenish paper. An opening/closing sensor 151p and a size sensor 151s are arranged corresponding to the paper feed cassette 151. The opening/closing sensor 151p turns on when the paper feed cassette 151 is in a closed state, and turns off when the paper feed cassette 151 is in an opened state, to detect opening/closing of the paper feed cassette 151. The size sensor 151s detects the size of paper, which is a recording medium contained in the paper feed cassette 151. For example, the size sensor 151s detects the position of a partition plate provided on the paper feed cassette 151. Similarly, an opening/closing sensor 152p and a size sensor 152s are arranged corresponding to the paper feed cassette 152, and an opening/closing sensor 153p and a size sensor 153s are arranged corresponding to the paper feed cassette 153. The opening/closing sensor 152p detects opening/closing of the paper feed cassette 152, and the size sensor 152s detects the size of paper, which is a recording medium contained in the paper feed cassette 152. The opening/closing sensor 153p detects opening/closing of the paper feed cassette 153, and the size sensor 153s detects the size of paper, which is a recording medium contained in the paper feed cassette 153.

The manual insertion cassette 154 is provided on a sidewall 101 of the MFP 100 and is positioned below the image former 140. The manual insertion cassette 154 varies between states: a closed state in which the manual insertion cassette 154 is in a position parallel to the sidewall 101 and an opened state in which the manual insertion cassette 154 is in a position of forming a predetermined angle with the sidewall 101. The manual insertion cassette 154 has an open upper side in the opened state such that the user can replenish paper. An opening/closing sensor 154p and a size sensor 154s are arranged corresponding to the manual insertion cassette 154. The opening/closing sensor 154p turns on when the manual insertion cassette 154 is in a closed state, and turns off when the manual insertion cassette 154 in an opened state, to detect opening/closing of the manual insertion cassette 154. The size sensor 154s detects the size of paper, which is a recording medium contained in the manual insertion cassette 154. For example, the size sensor 154s detects the position of a partition plate provided on the manual insertion cassette 154.

The opening/closing sensors 151p to 154p and the size sensors 151s to 154s are sensors that can detect a tangible object. The opening/closing sensors 151p to 154p and the size sensors 151s to 154s are not limited, but may, for example, be a photoelectronic sensor or a pressure sensor.

As indicated by the bold dash-dotted line in FIG. 3, in the paper feeder 150, a sub-conveyance path SP1 is formed to extend from the paper feed cassette 151 positioned at the upper stage among the three paper feed cassettes 151, 152, 153 to the lower end portion 30 of the main conveyance path 41. In addition, a sub-conveyance path SP2 is formed to extend from the manual insertion cassette 154 to the lower end portion 30 of the main conveyance path 41. Furthermore, two conveyance paths 152a, 153a are formed to extend from the paper feed cassette 152, 153 positioned at the intermediate and lower stages, respectively, among the three paper feed cassettes 151, 152, 153 to the lower end portion 30 of the main conveyance path 41. A portion of a predetermined length from the lower end portion 30 of the main conveyance path 41 to each of the two conveyance paths 152a, 153a is a sub-conveyance path SP3 that is shared by the two conveyance paths 152a, 153a.

The sub-conveyance path SP1 includes a paper feed roller 151r for feeding the paper received in the paper feed cassette 151 to the main conveyance path 41. The sub-conveyance path SP2 includes a paper feed roller 154r for feeding paper received in the manual insertion cassette 154 to the main conveyance path 41. The conveyance path 152a includes a paper feed roller 152r for feeding the paper received in the paper feed cassette 152 to the main conveyance path 41 through the sub-conveyance path SP3. The conveyance path 153a includes a paper feed roller 153r for feeding the paper received in the paper feed cassette 153 to the main conveyance path 41 through the sub-conveyance path SP3.

In the MFP 100, when an image is formed on the paper, a cassette that receives the paper on which an image is formed is selected as a target cassette from among the three paper feed cassettes 151, 152, 153 and the manual insertion cassette 154. When the paper feed roller corresponding to the cassette selected as a target cassette from among the three paper feed cassettes 151, 152, 153 and the manual insertion cassette 154 is operated, the paper on which an image is formed is fed from the cassette selected as the target cassette to the main conveyance path 41 through any of the sub-conveyance paths SP1, SP2, SP3.

The image former 140 includes image formation units 51Y, 51M, 51C, 51K for yellow, magenta, cyan, and black. An image is formed when at least one of the image formation units 51Y, 51M, 51C, 51K is driven. A full color image is formed when all of the image formation units 51Y, 51M, 51C, 51K are driven. Yellow, magenta, cyan and black printing data is input to the image formation units 51Y, 51M, 51C, 51K. The image formation units 51Y, 51M, 51C, 51K are only different in what toner color they handle. Therefore, here, the image formation unit 51Y for forming a yellow image is described.

The image formation unit 51Y includes an exposure head to which yellow printing data is input, a photoreceptor drum (image carrier), an electric charger, a developer, and a transfer roller 53Y. The exposure head emits laser light depending on received printing data (electric signal). The emitted laser light is one-dimensionally emitted by a polygon mirror of the exposure head to expose the photoreceptor drum. A direction in which the photoreceptor drum is one-dimensionally scanned is a main scanning direction. The photoreceptor drum is charged by the electric charger and irradiated with the laser light emitted by the exposure head. Thus, an electrostatic latent image is formed on the photoreceptor drum. Then, a toner image is formed when a toner is placed on the electrostatic latent image by the developer. The toner image formed on the photoreceptor drum is transferred onto an intermediate transfer belt 57 by the transfer roller 53Y.

Meanwhile, the intermediate transfer belt 57 is suspended over a drive roller 55 and a roller 55A without sagging. When the drive roller 55 is rotated counterclockwise in the drawing, the intermediate transfer belt 57 is rotated counterclockwise in the drawing at a predetermined speed. The roller 55A is rotated counterclockwise by the rotation of the intermediate transfer belt 57.

Thus, the image formation units 51Y, 51M, 51C, 51K transfer a toner image onto the intermediate transfer belt 57 sequentially. The timing at which the image formation units 51Y, 51M, 51C, 51K transfer a toner image onto the intermediate transfer belt 57 is adjusted as a reference mark attached to the intermediate transfer belt 57 is detected. Thus, the toner images of yellow, magenta, cyan and black are superimposed onto the intermediate transfer belt 57.

In the main conveyance path 41, from the lower end portion 30 to the upper end portion 13, a timing roller 45, a transfer roller 47, and a fixing roller 49 are arranged in this order at intervals. The paper fed from the paper feeder 150 to the main conveyance path 41 is delivered to the timing roller 45.

The timing roller 45 adjusts a paper conveyance state in the main conveyance path 41 such that the paper arrives at the transfer roller 47 at a timing when the toner image formed on the intermediate transfer belt 57 arrives at the transfer roller 47. The paper conveyed by the timing roller 45 is pressed against the intermediate transfer belt 57 by the transfer roller 47. When the transfer roller 47 is electrically charged, the yellow, magenta, cyan, and black toner images formed on the intermediate transfer belt 57 in a superimposed manner are transferred to the paper. The voltage applied to the transfer roller 47 is controlled by the CPU 111 such that the electric charge amount of the transfer roller 47 becomes suitable for the basis weight of the paper.

The paper onto which the toner images are transferred is conveyed to the fixing roller 49 and heated by the fixing roller 49. Thus, the toner is melted and fixed to the paper. Then, the paper after image formation is discharged onto the paper discharge tray 159 from the upper end portion 13 of the main conveyance path 41 by the paper discharge roller 15. The temperature of the fixing roller 49 is controlled by the CPU 111 so as to be suitable for the basis weight of the paper.

In the MFP 100 of the present embodiment, a detector 59 having a detection region is provided in the main conveyance path 41. The detector 59 includes a light projector 59a and a light receiver 59b, and is arranged such that the light projector 59a and the light receiver 59b are opposite to each other across the main conveyance path 41 in a position between the lower end portion 30 and the timing roller 45 of the main conveyance path 41. The light projector 59a includes a light emitting element, e.g., a light emitting diode, a drive circuit of the light emitting element, and an optical system, and emits light along the optical axis. A region in the main conveyance path 41 that follows the optical axis of the light projector 59a is a detection region. The light receiver 59b includes a light receiving element, e.g., a photodiode, and outputs a signal corresponding to the amount of light the light receiving element receives. The detection region of the detector 59 is a region between the light projector 59a and the light receiver 59b.

The detector 59 emits a preset amount of light from the light projector 59a to the detection region. In this state, when the paper is moved to traverse the detection region, the light is emitted to part of the moving paper. At this time, part of the light emitted to the paper penetrates the paper, and the remaining light is absorbed by the paper or reflected off the paper. The light receiver 59b receives the light that has penetrated the paper, and outputs a signal corresponding to the amount of light to the CPU 111.

In the CPU 111, the medium type of the paper that moves in the detection region is determined on the basis of the output signal of the light receiver 59b. Specifically, the ratio of the amount of light the light receiver 59b receives to the amount of light the light projector 59a emits is calculated as transmissivity, and the basis weight with respect to the transmissivity is determined. Furthermore, the basis weights with respect to a plurality of medium types are preliminarily determined by experiments or the like to determine the medium type from the basis weight. Here, the medium type is normal paper, high quality paper, and cardboard. The CPU 111 sets image formation conditions of the paper on the basis of the acquired medium type. The image formation conditions of paper include voltage to be applied to the transfer roller 47 required for proper transfer of the toner image formed on the intermediate transfer belt 57 to the paper, and temperature of the fixing roller 49 required for proper fixation of the toner image, which has been transferred to the paper, to the paper. For example, when the basis weight is large, the amount of electric charge of the transfer roller 47 is set larger than in the case where the basis weight is small and the temperature of the fixing roller 49 is set higher than in the case where the basis weight is small. Meanwhile, when the basis weight of paper is small, the amount of electric charge of the transfer roller 47 is set smaller than in the case where the basis weight is large and the temperature of the fixing roller 49 is set lower than in the case where the basis weight is large. In addition, the image formation conditions of paper include conveyance speed of paper required for transfer and fixation of the toner image to the paper. For example, the conveyance speed of paper having a large basis weight is set slower than the conveyance speed of paper having a small basis weight. In addition, the conveyance speed of paper having a small basis weight is set quicker than the conveyance speed of paper having a large basis weight. Note that the conveyance speed of paper can be adjusted by control of the rotation rates of the timing roller 45, the transfer roller 47, the fixing roller 49, and the paper discharge roller 15.

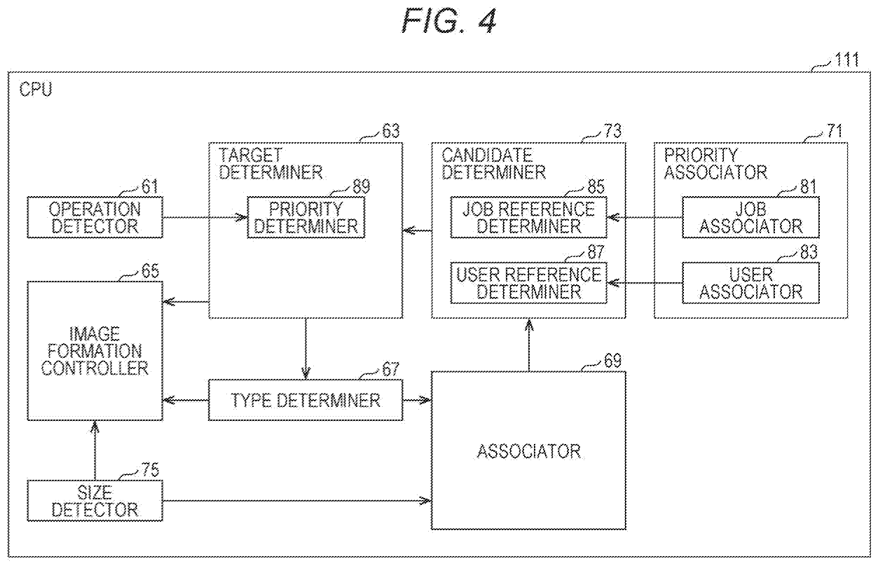

FIG. 4 is a block diagram illustrating an example of a function of a CPU of an MFP according to the first embodiment. The function illustrated in FIG. 4 is a function that is formed in the CPU 111 when the CPU 111 of the MFP 100 executes an image formation program stored in the ROM 113, the HDD 115, or the CD-ROM 118A.

Here, description is given of an example in which the paper the medium type of which is “normal paper” is contained in the paper feed cassette 151, the paper the medium type of which is “high quality paper” is contained in the paper feed cassette 152, and the paper the medium type of which is “cardboard” is contained in the paper feed cassette 153, and no paper is contained in the manual insertion cassette 154.

Referring to FIG. 4, the CPU 111 includes an operation detector 61, a target determiner 63, an image formation controller 65, a type determiner 67, an associator 69, a priority associator 71, a candidate determiner 73, and a size detector 75.

The size detector 75 detects the sizes of paper contained in the three paper feed cassettes 151, 152, 153 and the manual insertion cassette 154. Specifically, the sizes of paper is detected on the basis of the outputs of the size sensors 151s, 152s, 153s, 154s. The size detector 75 outputs the sizes of paper contained in the three paper feed cassettes 151, 152, 153 and the manual insertion cassette 154 to the image formation controller 65 and the associator 69.

The associator 69 associates the size of paper received in the cassettes and the medium type with respect to the three paper feed cassettes 151, 152, 153 and the manual insertion cassette 154. Specifically, in the HDD 115 is stored an association table including an association record including cassette identification information for identifying the three paper feed cassettes 151, 152, 153 and the manual insertion cassette 154 and the size of paper and the medium type received in the cassettes. In a case where the size of paper contained in the three paper feed cassettes 151, 152, 153 and the manual insertion cassette 154 is input from the size detector 75, the associator 69 updates the association table when the size is different from the size stored in the association table.

The priority associator 71 presets priority with respect to a plurality of medium types of paper. The priority associator 71 includes a job associator 81 and a user associator 83. The job associator 81 associates priority with respect to the plurality of medium types of paper for each of a plurality of job types indicating the type of print job. Specifically, a job priority table in which priority is added for each of the plurality of medium types of paper is stored in the HDD 115 with respect to each of the plurality of job types. The print job includes the job type and the image formation condition. The image formation condition specifies an operation executed by the image former 140 to form an image. The job type is not limited, but is, for example, information for distinguishing intended purposes and the degree of security. The type of intended purposes indicate purposes of use of a print medium, e.g., for internal distribution or for external distribution. The type indicating the degree of security indicates the degree of security, e.g., confidential or restricted to the department. Here, description is given of an example in which the type of print job is the type of intended purposes.

The user associator 83 associates priority with the plurality of medium types of paper with respect to each user. Specifically, a user priority table in which priority is added for each of the plurality of medium types of paper is stored in the HDD 115 with respect to each of the plurality of users.

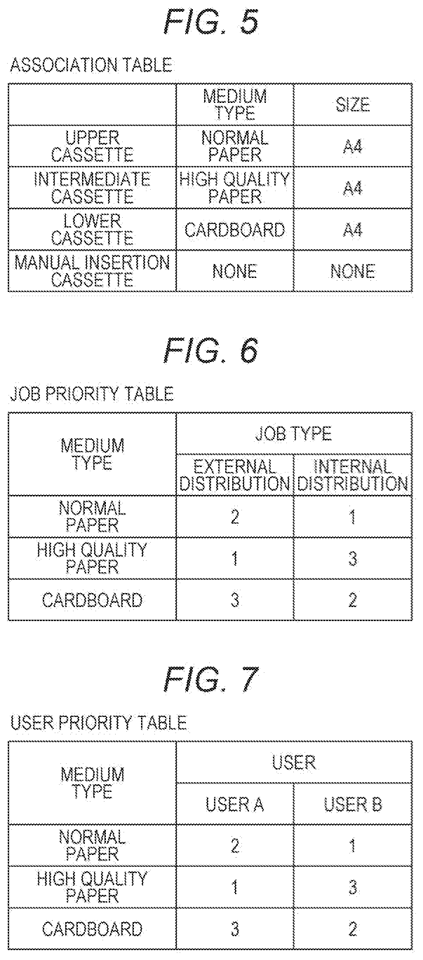

FIG. 5 is a view illustrating an example of the association table. Referring to FIG. 5, the medium type “normal paper” and the size “A4” are associated with cassette identification information “upper cassette” for identifying the paper feed cassette 151, the medium type “high quality paper” and the size “A4” are associated with cassette identification information “intermediate cassette” of the paper feed cassette 152, and the medium type “cardboard” and the size “A4” are associated with cassette identification information “lower cassette” of the paper feed cassette 153. In addition, the medium type “none” and the size “none” are associated with cassette identification information “manual insertion cassette” of the manual insertion cassette 154, indicating that no paper is contained in the manual insertion cassette 154.

FIG. 6 is a view illustrating an example of the job priority table. Referring to FIG. 6, with regard to the type of print job: external distribution, the medium type “normal paper” is given priority “2,” the medium type “high quality paper” is given priority “1,” and the medium type “cardboard” is given priority “3.” In addition, with regard to the type of print job: internal distribution, the medium type “normal paper” is given priority “1,” the medium type “high quality paper” is given priority “3,” and the medium type “cardboard” is given priority “2.”

FIG. 7 is a view illustrating an example of the user priority table. Referring to FIG. 7, with regard to user A, the medium type “normal paper” is given priority “2,” the medium type “high quality paper” is given priority “1,” and the medium type “cardboard” is given priority “3.” In addition, with regard to user B, the medium type “normal paper” is given priority “1,” the medium type “high quality paper” is given priority “3,” and the medium type “cardboard” is given priority “2.”

Referring back to FIG. 3, the candidate determiner 73 determines a candidate cassette from among the three paper feed cassettes 151, 152, 153 and the manual insertion cassette 154. The candidate cassette is a cassette to be a candidate of a target cassette to be described later. The candidate determiner 73 outputs the cassette identification information for identifying a candidate cassette to the target determiner 63 in determining a candidate cassette. The candidate determiner 73 includes a job reference determiner 85 and a user reference determiner 87.

When print job is accepted and the print job specifies a job type, the job reference determiner 85 determines a candidate cassette on the basis of the job type. The job reference determiner 85 accepts the print job when the communication I/F 112 receives the print job from the outside. In addition, when the user operating the operation unit 163 inputs the job type in addition to the print job, the print job and the job type are accepted. The job reference determiner 85 refers to the job priority table stored in the HDD 115 by the job associator 81 and acquires the priority of each of the plurality of medium types corresponding to the job type of the print job. The job reference determiner 85 refers to the association table stored in the HDD 115 by the associator 69 and determines a cassette that contains the paper of the medium type that has the highest priority among the three paper feed cassettes 151, 152, 153 and the manual insertion cassette 154, as the candidate cassette.

The user reference determiner 87 determines a candidate cassette on the basis of a log-in user when the user operates the operation unit 163 to log in. The user reference determiner 87 refers to the user priority table stored in the HDD 115 by the user associator 83 and acquires the priority of each of the plurality of medium types corresponding to the log-in user. The user reference determiner 87 refers to the association table stored in the HDD 115 by the associator 69 and determines a cassette that contains the paper of the medium type that has the highest priority among the three paper feed cassettes 151, 152, 153 and the manual insertion cassette 154, as the candidate cassette.

The candidate determiner 73 outputs the candidate cassette determined by the user reference determiner 87 or the job reference determiner 85 to the target determiner 63. For example, when the candidate cassettes are determined by the user reference determiner 87 and the job reference determiner 85 and they are different, it is sufficient if the candidate cassette determined by the job reference determiner 85 has priority over the candidate cassette determined by the user reference determiner 87. In addition, when the candidate cassettes determined by the user reference determiner 87 and the job reference determiner 85 are different, the candidate cassette determined by the user reference determiner 87 may have priority over the candidate cassette determined by the job reference determiner 85.

The operation detector 61 detects a user operation input by the user. The operation detector 61 detects the containing operation for containing the recording medium in any of the three paper feed cassettes 151, 152, 153, as one user operation. The operation detector 61 detects the containing operation on the basis of the output of the opening/closing sensors 151p, 152p, 153p when the user opens or closes any of the three paper feed cassettes 151, 152, 153. For example, the operation detector 61 detects the operation of opening the paper feed cassette 151 as a user operation as the opening/closing sensor 151p detects a change from on to off, and detects the operation of closing the paper feed cassette 151 as a user operation as the opening/closing sensor 151p detects a change from off to on. The operation detector 61 detects the containing operation of containing the recording medium in the paper feed cassette 151 after the operation of opening the paper feed cassette 151 is detected when the operation of closing the paper feed cassette 151 is detected. In addition, when the user opens or closes the manual insertion cassette 154, the containing operation of containing the recording medium in the manual insertion cassette 154 is detected on the basis of the output of the opening/closing sensor 154p. Note that, in addition to the opening/closing sensors 151p to 154p, a sensor that detects the presence or absence or the number of contained recording media may be provided to detect the containing operation when a change from the state of absence to the state of presence of the recording medium or an increase in number of recording media contained is detected.

In addition, the operation detector 61 accepts an operation in which the user provides input to the operation unit 163 as one user operation. The operation detector 61 detects an operation accepted by the operation unit 163 as a user operation when the operation unit 163 accepts an operation input by the user.

The target determiner 63 determines a candidate cassette from among the three paper feed cassettes 151, 152, 153 and the manual insertion cassette 154. The target determiner 63 outputs cassette identification information of the determined target cassette to the image formation controller 65. The target cassette is a cassette for containing the paper on which the image is formed by the image former 140. The target determiner 63 includes a priority determiner 89. The priority determiner 89 determines a cassette for which the containing operation has been detected among the three paper feed cassettes 151, 152, 153 and the manual insertion cassette 154 as a priority cassette before an execution instruction operation is detected when the containing operation is detected by the operation detector 61. The target determiner 63 determines a cassette for which the final containing operation has been detected as a priority cassette when the containing operation is detected multiple times.

However, the priority determiner 89 does not determine a priority cassette when the time of not detecting the user operation is equal to or more than a predetermined time in a period of time from the detection of the user operation by the operation detector 61 to the detection of an execution instruction operation. The user operation includes the containing operation. Accordingly, the priority determiner 89 does not determine a priority cassette when the time of not detecting the user operation is equal to or more than the predetermined time in a period of time from the detection of the containing operation to the detection of the execution instruction operation. The containing operation may be a user operation that is input first or a user operation that is input secondly onward. This is because when a predetermined time elapses without input of a user operation by the user, there is a low possibility that the user who inputs the user operation detected before the predetermined time elapses is the same as the user who inputs the user operation detected after the predetermined time elapses. Therefore, the priority determiner 89, when the predetermined time elapses without the input of the user operation by the user, determines that the user who contains the paper in any of the three paper feed cassettes 151, 152, 153 and the manual insertion cassette 154 is not the same as the user who inputs the execution instruction operation, and does not determine the priority cassette.

The target determiner 63 determines a default set cassette as a target cassette when any of the three paper feed cassettes 151, 152, 153 and the manual insertion cassette 154 is set as a default cassette in the MFP 100. The target determiner 63, even when any of the three paper feed cassettes 151, 152, 153 and the manual insertion cassette 154 is set as a default cassette, determines a specified cassette specified by the user as a target cassette when any of the three paper feed cassettes 151, 152, 153 and the manual insertion cassette 154 is specified by the user. An example of the case in which the specified cassette is specified by the user is, for example, a case in which the size of paper is specified by the user or a case in which any of the three paper feed cassettes 151, 152, 153 and the manual insertion cassette 154 is specified by the user.

The target determiner 63, when the user inputs a user operation of specifying the size of paper to the operation unit 163, determines a cassette in which paper of the size specified by the user among the three paper feed cassettes 151, 152, 153 and the manual insertion cassette 154 is contained as a specified cassette. In addition, the target determiner 63, when the user inputs a user operation of specifying any of the three paper feed cassettes 151, 152, 153 and the manual insertion cassette 154 to the operation unit 163, determines a cassette specified by the user among the three paper feed cassettes 151, 152, 153 and the manual insertion cassette 154 as a specified cassette.

The target determiner 63, even when a default cassette is set or when a specified cassette is specified by the user, determines a candidate cassette as the target cassette when the candidate cassette is determined by the candidate determiner 73. The target determiner 63, when a default cassette is set, even when the specified cassette is specified by the user or the candidate cassette is determined by the candidate determiner 73, when the priority cassette is determined by the priority determiner 89, determines the priority cassette as the target cassette. This is because when the user contains the paper in any of the three paper feed cassettes 151, 152, 153 and the manual insertion cassette 154, there is a large possibility that the paper to which an image is formed is contained.

The target determiner 63 outputs cassette identification information of the target cassette to the image formation controller 65. The image formation controller 65 controls the paper feeder 150 to convey the paper from the target cassette among the three paper feed cassettes 151, 152, 153 and the manual insertion cassette 154 and cause the image former 140 to form an image. The image formation controller 65 causes the image former 140 to form an image on the paper under the image formation condition corresponding to the medium type of the paper contained in the target cassette.

When the priority cassette is determined to be the target cassette by the target determiner 63, the paper is contained in the target cassette by the user. Therefore, the paper of a medium type that is different from the medium type associated with the target cassette by the associator 69 can be contained in the target cassette. Therefore, the medium type of the paper contained in the target cassette is unclear. The target determiner 63 outputs a determination instruction to the type determiner 67 when the priority cassette is determined to be the target cassette.

The image formation controller 65, when the priority cassette is determined to be the target cassette by the target determiner 63, controls the paper feeder 150 to convey the paper from the priority cassette to the timing roller 45. For example, the image formation controller 65 rotates the paper feed roller 151r when the priority cassette is the paper feed cassette 151, rotates the paper feed roller 152r when the priority cassette is the paper feed cassette 152, rotates the paper feed roller 153r when the priority cassette is the paper feed cassette 153, and rotates the paper feed roller 154r when the priority cassette is the manual insertion cassette 154. The conveyance speed of paper in this case is the slowest conveyance speed among conveyance speeds specified with respect to the plurality of medium types. Conveyance is performed at the slowest conveyance speed. Therefore, conveyance is performed at a conveyance speed for a medium type having the largest basis weight. When the paper of a medium type having the largest basis weight is conveyed at a conveyance speed faster than the corresponding conveyance speed, the timing roller 45 can be damaged when the paper contacts the timing roller 45 or the like. Therefore, conveyance is performed at a conveyance speed corresponding to a medium type having the largest basis weight to prevent a member. e.g., the timing roller 45, arranged in the conveyance path from being damaged.

The paper passes the detection region of the detector 59 while the paper is conveyed from the priority cassette to the timing roller 45. The type determiner 67 controls the detector 59 and, when the paper is present in the detection region, acquires an output signal of the light receiver 59b of the detector 59 to determine the basis weight corresponding to the output signal on the basis of conversion information. The conversion information is information that specifies a relationship between transmissivity indicated by the output signal of the detector 59 and the basis weight of the paper. The conversion information is a table or a conversion formula. The type determiner 67 outputs the medium type corresponding to the determined basis weight to the image formation controller 65 and the associator 69.

The associator 69 updates the association table when the medium type is input front the type determiner 67. Specifically, the medium type associated with the priority cassette is updated by the medium type input from the type determiner 67. Next, it is efficient if the association table is not changed until the paper is contained in any of the three paper feed cassettes 151, 152, 153 and the manual insertion cassette 154.

The image formation controller 65, when the medium type is input from the type determiner 67, determines the image formation condition corresponding to the size of paper and the medium type, controls the image former 140 to form an image on the paper under the determined image formation condition.

The image formation condition includes a printing data generation condition voltage applied to the transfer roller 47, the temperature of the fixing roller 49, and the conveyance speed of paper. The image formation controller 65 determines the size of paper contained in the target cassette on the basis of the size of paper input from the size detector 75, and determines the printing data generation condition using the size of paper to generate printing data according to the generation condition. The printing data is data used for the image former 140 to form an image, and is, for example, bitmap data. The printing data corresponds to the size of paper on which an image is formed, and specifies an image to be formed on the paper by a plurality of pixel values. The printing data includes four pieces of data corresponding to yellow, magenta, cyan, and black, respectively. The image formation controller 65 conveys the paper conveyed to the timing roller 45 at a conveyance speed determined according to the medium type, applies a voltage determined according to the medium type to the transfer roller 47, and controls the fixing roller 49 to the temperature determined according to the medium type.

<Variation of the Priority Determiner 89>

The priority determiner 89 of a variation determines a cassette for which the containing operation has been detected finally as the priority cassette from among the three paper feed cassettes 151, 152, 153 and the manual insertion cassette 154 when a user who operates the MFP 100 is authenticated and when the containing operation is detected in a period of time from when the user logs in to the time when the user logs out. However, the priority determiner 89 does not determine the priority cassette when the predetermined time elapses from when the containing operation is detected. This is because when the predetermined time elapses after the log-in user performs the containing operation of containing the paper in any of the three paper feed cassettes 151, 152, 153 and the manual insertion cassette 154, there is a small possibility that the user uses the paper received in the cassette that contains the paper.

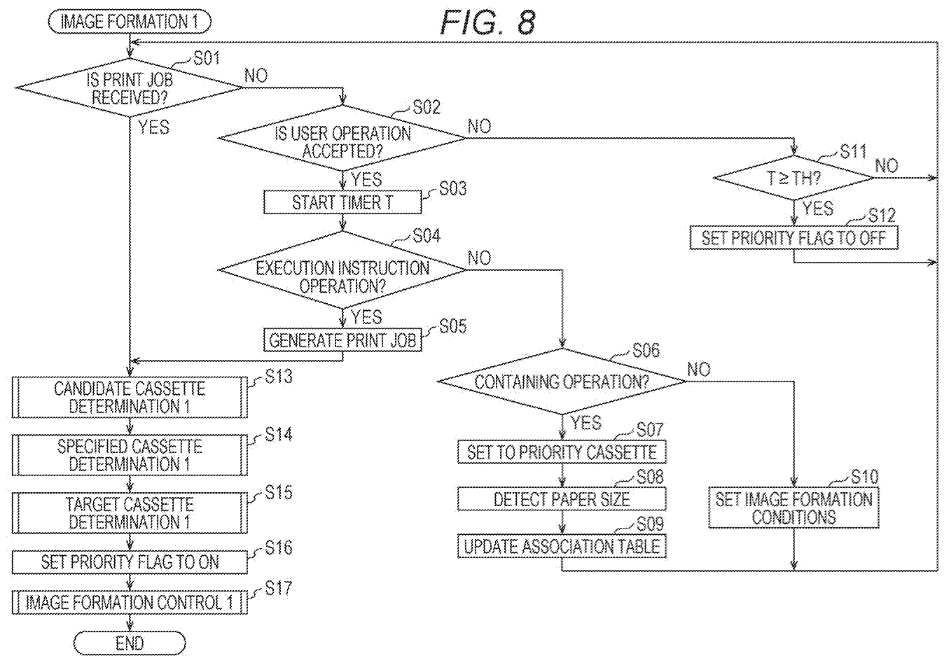

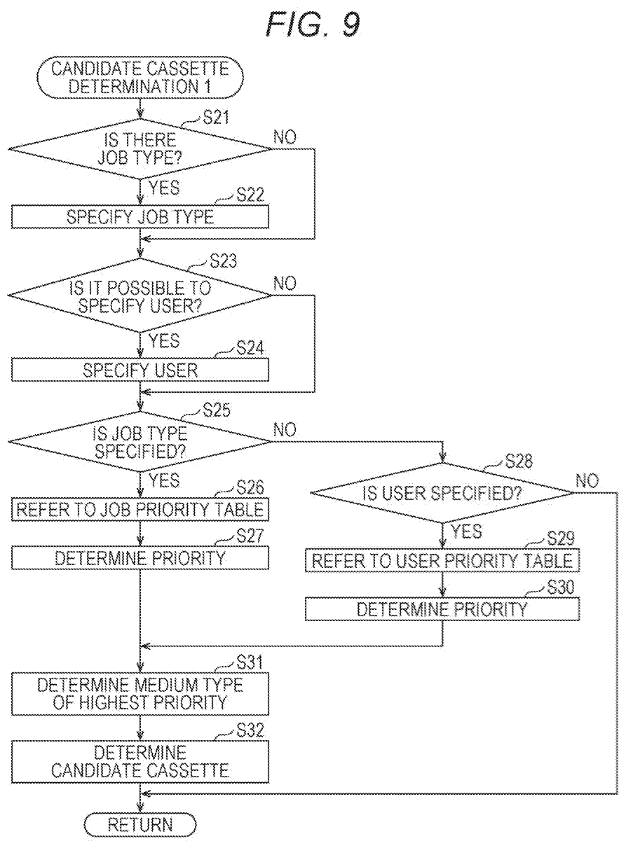

FIG. 8 is a flowchart illustrating an example of flow of an image formation processing according to the first embodiment. The image formation processing is processing that is executed by the CPU 111 when the CPU 111 of the MFP 100 executes the image formation program stored in the ROM 113, the HDD 115, or the CD-ROM 118A. Referring to FIG. 8, the CPU 111 of the MFP 100 determines whether the print job has been received (step S01). When the communication I/F 112 receives the print job, the processing proceeds to step S10, and if not the processing proceeds to step S02.

In step S02, it is determined whether the user operation input to the MFP 100 by the user has been accepted. When the user operation has been accepted, the processing proceeds to step S03, and if not the processing proceeds to step S06. When the user operates the operation unit 163, the operation input to the operation unit 163 by the user is accepted as the user operation. In addition, when the MFP 100 is remotely operated by a portable device. e.g., a smartphone, the communication I/F 112 communicates with the portable device. In this case, when the communication I/F 112 receives a remote operation from the portable device, the operation input by the user is accepted as the user operation. In addition, when any of the three paper feed cassettes 151, 152, 153 and the manual insertion cassette 154 is changed to the opened state or the closed state, the containing operation is accepted as the user operation.

In step S03, passing of time of a timer T starts, and the processing proceeds to step S04. The timer T counts time elapsed after the user operation is accepted. In step S04, it is determined whether the user operation accepted in step S02 is an execution instruction operation that indicates execution of a job. When the execution instruction operation has been accepted, the processing proceeds to step S05, and if not the processing proceeds to step S06. In step S05, the print job is generated and the processing proceeds to step S13.

In step S06, it is determined whether the user operation accepted in step S02 is a containing operation. When the containing operation has been accepted, the processing proceeds to step S07, and if not the processing proceeds to step S10. In step S10, the image formation condition is set according to the user operation accepted in step S02, and the processing returns to step S01.

In step S07, a cassette for winch the containing operation accepted in step S02 has been detected among the three paper feed cassettes 151, 152, 153 and the manual insertion cassette 154 is set to the priority cassette, and the processing proceeds to step S08. In next step S08, the size of paper contained in the priority cassette is detected and the processing proceeds to step S09. Then, the association table stored in the HDD 115 is updated and the processing returns to step S01. Specifically, in the association table, the size of paper associated with the priority cassette is updated by the size of paper detected.

In step S11, it is determined whether the value of the timer T is equal to or more than a threshold TH. When the value of the timer T is equal to or more than the threshold TH, the processing proceeds to step S12, and if not the processing returns to step S01. In step S12, the priority flag is set to off, and the processing returns to step S01. The priority flag is a flag indicating whether the priority cassette is valid or invalid as will be described later. The case in which the priority flag is on indicates that the priority cassette is valid, and the case in which the priority flag is off indicates that the priority cassette is invalid. Accordingly, the priority cassette is set to invalid when a predetermined time elapses after the user operation is accepted and before a next user operation is accepted. In addition, step S11 may be executed after the containing operation is detected in step S06. Thus, after the user opens or closes any of the three paper feed cassettes 151, 152, 153 and the manual insertion cassette 154, when the time in which the user operation is not detected becomes equal to or more than the predetermined time, the priority cassette can be set to invalid.

When the processing proceeds to step S13, the print job, which is a processing target, has been determined. When the processing proceeds to step S13 from step S01, the print job received from the outside has been determined as a processing target in step S01. When the print job proceeds to step S13 from step S05, the print job generated in step SOS has been determined as a processing target. In step S13, the candidate cassette determination processing is executed and the processing proceeds to step S14. In step S14, the specified cassette determination processing is executed and the processing proceeds to step S15. In step S15, the target cassette determination processing is executed and the processing proceeds to step S16. Details of the candidate cassette determination processing and the specified cassette determination processing will be described later. The candidate cassette can be determined when the candidate cassette determination processing is executed, and the specified cassette can be determined when the specified cassette determination processing is executed. In addition, the target cassette is determined when the target cassette determination processing is executed. The target cassette is a cassette among the three paper feed cassettes 151, 152, 153 and the manual insertion cassette 154, which cassette contains the paper on which the image is formed. In next step S16, the priority flag is set to on, and the processing proceeds to step S17. In step S17, the image formation control processing is executed and the processing ends.

FIG. 9 is a flowchart illustrating an example of flow of the candidate cassette determination processing according to the first embodiment. The candidate cassette determination processing is processing executed in step S13 of the image formation processing. The print job, which is a processing target, is determined in a stage before the candidate cassette determination processing is executed. Referring to FIG. 9, the CPU 111 determines whether the job type has been set in the print job (step S21). When the job type has been set, the processing proceeds to step S22, and if not step S22 is skipped and the processing proceeds to step S23. When the print job is received from the outside, the job type has been set to the print job in some cases. In addition, the job type can be received together with the print job. When the print job is generated by the operation of the operation unit 163 by the user, the job type can be set by the user. In step S22, the job type of the print job is specified, and the processing proceeds to step S23.

In step S23, it is determined whether it is possible to specify the user who has given an instruction of executing the print job. When the user can be specified, the processing proceeds to step S24, and if not step S24 is skipped and the processing proceeds to step S25. When the print job is received from the outside, the print job can include user identification information for identifying the user. In addition, the user identification information can be received together with the print job. When the print job is generated by the operation of the operation unit 163 by the user, the user who operates the operation unit 163 can be authenticated. In step S24, the user who has given an instruction of executing the print job is specified, and the processing proceeds to step S25. When the print job is received from the outside, the user identified by the user identification information included in the print job or by the user identification information received together with the print job is specified. When the print job is generated as the operation unit 163 is operated by the user, an authenticated log-in user is specified.

In step S25, it is determined whether the job type has been specified. When the job type has been specified in step S22, the processing proceeds to step S26, and if not the processing proceeds to step S28. In step S26, the job priority table is referenced. Specifically, the job priority table stored in the HDD 115 is read. Then, in the job priority table, the priority of each of the plurality of medium types specified with respect to the job type specified in step S22 is determined, and the processing proceeds to step S31.

In step S28, it is determined whether the user has been specified. When the user has been specified in step S24, the processing proceeds to step S29, and if not the processing returns to the image formation processing. In step S29, the user priority table is referenced. Specifically, the user priority table stored in the HDD 115 is read. Then, the priority of each of the plurality of medium types specified in the user priority table is determined with respect to the user specified in step S24, and the processing proceeds to step S31.

In next step S31, the medium type having the highest priority is determined, and the processing proceeds to step S32. When the processing proceeds from step S27, the medium type is determined according to the priority determined in step S27. When the priority proceeds from step S30, the medium type is determined according to the priority determined in step S30. The association table stored in the HDD 115 is referenced, and the medium type that has the highest priority is determined from among the medium types of paper contained in the three paper feed cassettes 151, 152, 153 and the manual insertion cassette 154. In step S32, the cassette that contains the paper of the medium type determined in step S31 is determined as the candidate cassette, and the processing returns to the image formation processing.

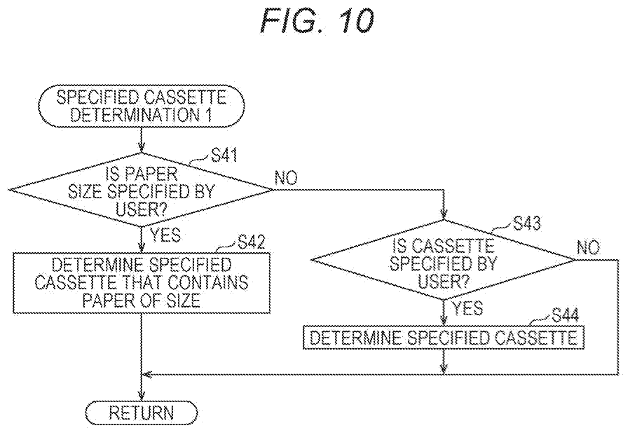

FIG. 10 is a flowchart illustrating an example of flow of a specified cassette determination processing according to the first embodiment. The specified cassette determination processing is processing executed in step S14 of the image formation processing. Referring to FIG. 10, the CPU 111 determines whether the specification of the paper size has been accepted by the user (step S41). When the user operation that specifies the paper size has been accepted by the operation unit 163, the processing proceeds to step S42, and if not the processing proceeds to step S43. In step S42, the cassette that contains the paper of the size specified by the user is determined as the specified cassette, and the processing returns to the image formation processing. The specified cassette is determined with reference to the association table stored in the HDD 115.

In step S43, it is determined whether any of the three paper feed cassettes 151, 152, 153 and the manual insertion cassette 154 has been specified by the user. When the operation unit 163 accepts the user operation that specifies any of the three paper feed cassettes 151, 152, 153 and the manual insertion cassette 154, the processing proceeds to step S44, and if not the processing returns to the image formation processing. In step S44, the cassette specified by the user from among the three paper feed cassettes 151, 152, 153 and the manual insertion cassette 154 is determined as the specified cassette, and the processing returns to the image formation processing.

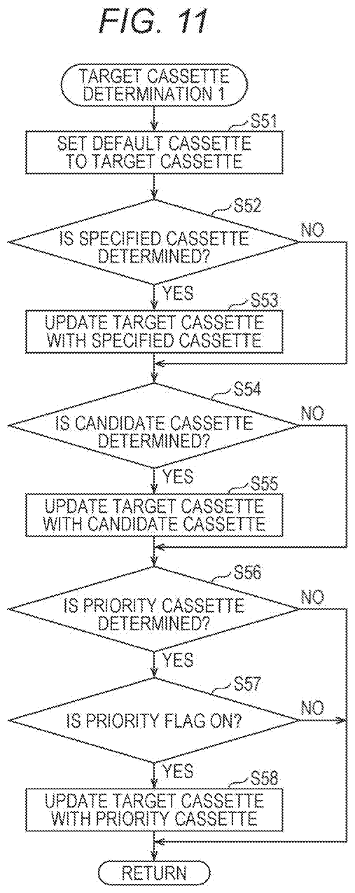

FIG. 11 is a flowchart illustrating an example of flow of a target cassette determination processing according to the first embodiment. In a state before the target cassette determination processing is executed, at least one of the candidate cassette, the specified cassette, and the priority cassette can be determined. Referring to FIG. 11, the CPU 111 sets a default set cassette among the three paper feed cassettes 151, 152, 153 and the manual insertion cassette 154 as a target cassette (step 551), and the processing proceeds to step S52.

In step S52, it is determined whether the specified cassette has been determined. When the specified cassette has been determined, the processing proceeds to step S53, and if not step S53 is skipped and the processing proceeds to step S54. In step 553, the target cassette is updated by the specified cassette, and the processing proceeds to step S54.

In step S54, it is determined whether the candidate cassette has been determined. When the candidate cassette has been determined, the processing proceeds to step S55, and if not step S55 is skipped and the processing proceeds to step S56. In step S55, the target cassette is updated by the candidate cassette, and the processing proceeds to step S56.

In step S56, it is determined whether the priority cassette has been determined. When the priority cassette has been determined, the processing proceeds to step S57, and if not the processing returns to the image formation processing. In step S57, it is determined whether the priority flag has been set to on. When the priority flag has been set to on, the processing proceeds to step 558, and if not the processing returns to the image formation processing. In step 558, the target cassette is updated by the priority cassette, and the processing returns to the image formation processing.

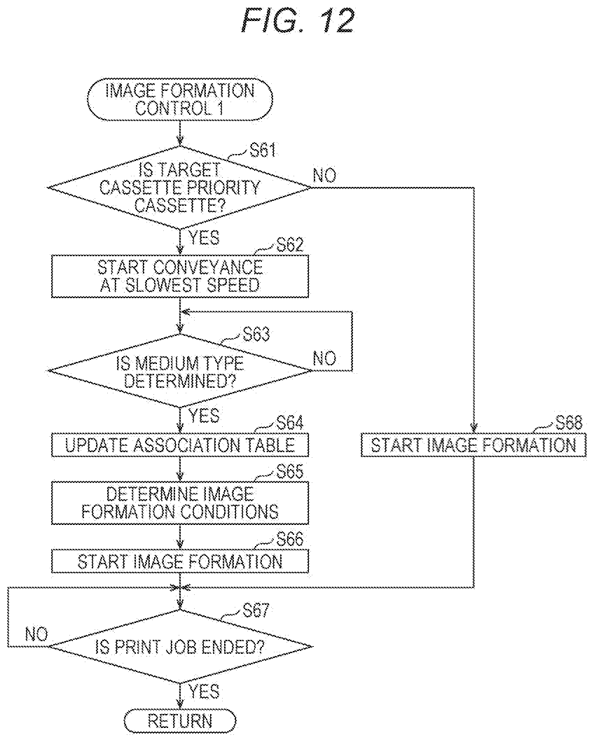

FIG. 12 is a flowchart illustrating an example of flow of an image formation control processing according to the first embodiment. The image formation control processing is processing executed in step S17 of the image formation processing. Referring to FIG. 12, the CPU 111 determines whether the target cassette is the priority cassette. When the target cassette is the priority cassette, the processing proceeds to step S62, and if not the processing proceeds to step S68. In step S68, image formation starts under the image formation condition that is determined at that point of time, and the processing proceeds to step S67.

In step S62, the conveyance of the paper to the timing roller 45 at the slowest conveyance speed starts, and the processing proceeds to step S63. Specifically, the paper feeder 150 is controlled to convey the paper contained in the priority cassette among the three paper feed cassettes 151, 152, 153 and the manual insertion cassette 154 to the timing roller 45 at the slowest conveyance speed. The conveyance speed is preset with respect to each of the plurality of types of medium types on which the image can be formed in the MFP 100. The paper is conveyed at the slowest conveyance speed. Therefore, conveyance is performed at a conveyance speed for a medium type having the largest basis weight. When the paper of a medium type having the largest basis weight is conveyed at a conveyance speed faster than the corresponding conveyance speed, the timing roller 45 can be damaged when the paper contacts the timing roller 45 or the like. Therefore, conveyance is performed at a conveyance speed corresponding to a medium type having the largest basis weight to prevent a member, e.g., the timing roller 45, arranged in the conveyance path from being damaged.

The paper passes the detection region of the detector 59 while the paper is conveyed to the timing roller 45. In step S63, it is determined whether the medium type of paper has been determined. A standby state is given until the medium type of paper is determined (NO in step S63). When the medium type of paper is determined (YES in step S63), the processing proceeds to S64. In step S64, the association table stored in the HDD 115 is updated and the processing proceeds to step S65. In the association table, the medium type associated with the priority cassette is updated by the medium type determined in step S63.

In step S65, the image formation condition corresponding to the medium type determined in step S63 is determined, and the processing proceeds to step S66. Specifically, the voltage applied to the transfer roller 47, the temperature of the fixing roller 49, and the conveyance speed of paper, which are part of the image formation condition, are set to values specified with respect to the medium type. In step S66, the image former 140 is controlled to form an image under the image formation condition determined in step S65. In next step S67, it is determined whether the print job has been ended. A standby state is given until the print job is ended, and the processing returns to the image formation processing when the print job is ended.

As described above, the MFP 100 according to the first embodiment functions as an image formation device, determines the priority cassette that finally contains the paper among the three paper feed cassettes 151, 152, 153 and the manual insertion cassette 154 that can contain the paper, which is a recording medium, as the target cassette, and forms an image on the paper contained in the target cassette. Therefore, because an image is formed on the paper that is contained by the user in any of the three paper feed cassettes 151, 152, 153 and the manual insertion cassette 154, it is not necessary for the user to set which of the three paper feed cassettes 151, 152, 153 and the manual insertion cassette 154 to use. Accordingly, the setting operation can be facilitated.

In addition, the MFP 100 determines the cassette for which the containing operation of containing the paper has been detected as the priority cassette from among the three paper feed cassettes 151, 152, 153 and the manual insertion cassette 154 in a period of time from when the user operation input by the user is detected to when the execution instruction operation is detected. Therefore, the case of determining the priority cassette can be limited to a case in which there is a high possibility that the user who inputs the execution instruction operation can be the same as the user who contains the paper.

In addition, the MFP 100 does not determine the priority cassette when the time in which the user operation by the user is not detected becomes equal to or more than the predetermined time. Therefore, it is possible to prevent the priority cassette from being determined when there is a high possibility that the user is changed during the operation.

In addition the MFP 100 determines the cassette for which the operation of containing the paper has been detected as the priority cassette from among the three paper feed cassettes 151, 152, 153 and the manual insertion cassette 154 from when the user's log-in is detected to when the user's log-out is detected. Therefore, the case of determining the priority cassette can be limited to a case in which there is a high possibility that the user who logs in can be the same as the user who contains the paper.

In addition, the MFP 100, when the predetermined time elapses from when the containing operation of containing the paper in any of the three paper feed cassettes 151, 152, 153 and the manual insertion cassette 154 has been detected, does not determine the priority cassette. Therefore, it is possible to prevent the priority cassette from being determined when there is a high possibility that the paper which is not used by the log-in user is contained.

In addition, the MFP 100 detects the containing operation of containing the paper in the opened/closed cassette among the three paper feed cassettes 151, 152, 153 and the manual insertion cassette 154 when the opening/closing of any of the three paper feed cassettes 151, 152, 153 and the manual insertion cassette 154 is detected. Therefore, the operation of containing the paper can easily be detected.

In addition, the MFP 100 determines the medium type detected by the detector 59 as the medium type of paper contained in the priority cassette when the detector 59 detects the medium type of the paper conveyed from the priority cassette to the paper feeder 150. Therefore, the medium type of the paper contained in the priority cassette can be determined.

In addition, the MFP 100 updates the association table when the medium type of the paper conveyed from the priority cassette is detected. Therefore, when the paper is contained in the priority cassette by the user, it is possible to associate the medium type of the paper with the priority cassette.

In addition, the MFP 100 refers to the job priority table or the user priority table, determines the cassette that contains the paper of the medium type having the highest priority as the candidate cassette from among the three paper feed cassettes 151, 152, 153 and the manual insertion cassette 154, forms an image on the paper contained in the candidate cassette when the priority cassette is not determined, and forms an image on the paper contained in the priority cassette when the priority cassette is determined. Therefore, when the paper is not contained by the user, an image is formed on the preset recording medium of the medium type having the priority. Therefore, it is possible to facilitate the setting operation.

In addition, the job priority table associates priority with a plurality of medium types of paper for each of the plurality of job types and determines the priority associated with the job type of the accepted job. Therefore, it is possible to form an image on the paper of medium type suitable for the job.

In addition, the user priority table associates priority with a plurality of medium types of paper for each of the plurality of users and determines the priority associated with the user who has given an instruction of executing the accepted job. Therefore, it is possible to form an image on the paper of medium type suitable for the user.

In addition, the MFP 100 forms an image on the paper under the image formation condition specified with respect to the medium type of paper. Therefore, it is possible to form an image with appropriate image quality with respect to the medium type.

In addition the MFP 100 forms an image on the paper under the image formation condition specified on the basis of the size of paper. Therefore, it is possible to form an image appropriate for the size of paper.

### Second Embodiment

The MFP 100 according to the first embodiment described above determines the priority cassette. The MFP 100 according to the second embodiment differs from the MFP 100 of the first embodiment in that the priority cassette is not determined. A difference between the MFP 100 according to the second embodiment and the MFP 100 according to the first embodiment is mainly described below.

The external appearance and the hardware configuration of the MFP 100 according to the second embodiment are the same as the external appearance and the hardware configuration of the MFP 100 according to the first embodiment illustrated in FIGS. 1 and 2. The internal configuration of the MFP 100 according to the second embodiment is the same as the internal configuration of the MFP 100 according to the first embodiment illustrated in FIG. 3 except for absence of the detector 59.

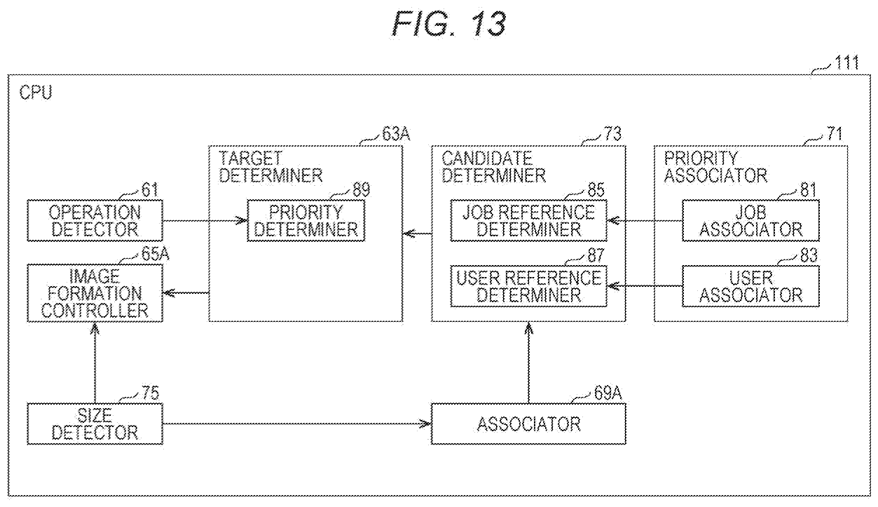

FIG. 13 is a block diagram illustrating an example of a function of a CPU of an MFP according to the second embodiment. The function illustrated in FIG. 13 differs from the function illustrated in FIG. 5 on the following points: the type determiner 67 is eliminated, and the target determiner 63, the image formation controller 65 and the associator 69 are changed to a target determiner 63A, an image formation controller 65A, and an associator 69A, respectively. The other functions are the same as the functions illustrated in FIG. 13 and will not be elaborated here.

The MFP 100 according to the second embodiment stores, in the HDD 115, the association table illustrated in FIG. 5, the job priority table illustrated in FIG. 6, and the user priority table illustrated in FIG. 7.

The associator 69A associates the size of paper and the medium type received in the cassettes with respect to the three paper feed cassettes 151, 152, 153 and the manual insertion cassette 154. Specifically, in the HDD 115 is stored an association table including an association record including cassette identification information for identifying the three paper feed cassettes 151, 152, 153 and the manual insertion cassette 154 and the size of paper and the medium type received in the cassettes. In a case where the size of paper contained in the three paper feed cassettes 151, 152, 153 and the manual insertion cassette 154 is input from the size detector 75, the associator 69A updates the association table when the size is different from the size stored in the association table.

The target determiner 63A determines a target cassette from among the three paper feed cassettes 151, 152, 153 and the manual insertion cassette 154. The target determiner 63A outputs cassette identification information of the determined target cassette to the image formation controller 65A. The target determiner 63A determines a default set cassette as a target cassette when any of the three paper feed cassettes 151, 152, 153 and the manual insertion cassette 154 is set as a default cassette in the MFP 100. The target determiner 63A, even when a default cassette is set, determines a specified cassette specified by the user as a target cassette when any of the three paper feed cassettes 151, 152, 153 and the manual insertion cassette 154 is specified by the user.

The target determiner 63A, even when a default cassette is set or when a specified cassette is specified by the user, determines a candidate cassette as the target cassette when the candidate cassette is determined by the candidate determiner 73.

The target determiner 63A outputs cassette identification information of the target cassette to the image formation controller 65A. The image formation controller 65A controls the paper feeder 150 to convey the paper from the target cassette from among the three paper feed cassettes 151, 152, 153 and the manual insertion cassette 154 and causes the image former 140 to form an image. The image formation controller 65A causes the image former 140 to form an image on the paper under the image formation condition corresponding to the medium type of the paper contained in the target cassette.

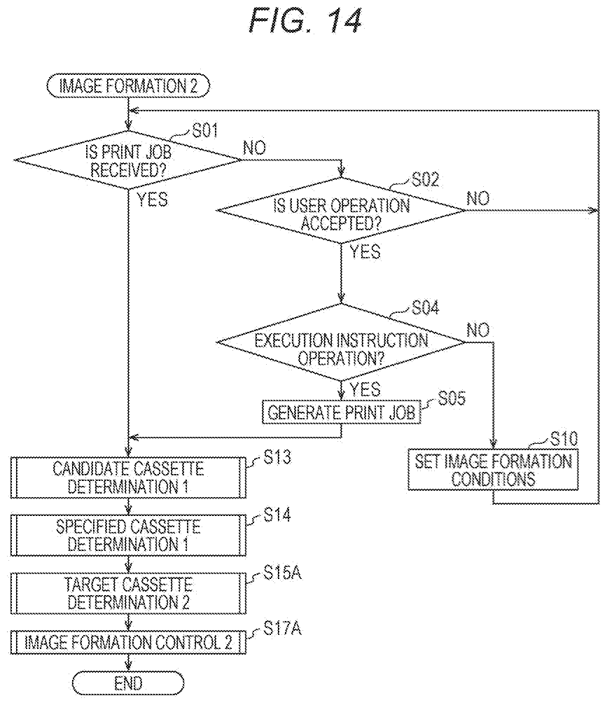

FIG. 14 is a flowchart illustrating an example of flow of an image formation processing according to the second embodiment. Referring to FIG. 14, differences from the image formation processing according to the second embodiment illustrated in FIG. 8 are as follows: steps S03, S06 to S09, S11, S12 and S16 are eliminated, and steps S15 and S16 are changed to steps S15A and S16A, respectively. The other processing is the same as the processing illustrated in FIG. 8 and will not be elaborated here. In step S02, when the operation is accepted, it is determined in next step S04 whether the accepted user operation is an execution instruction operation. When the execution instruction operation has been accepted, the processing proceeds to step 505, and if not the processing proceeds to step S10.

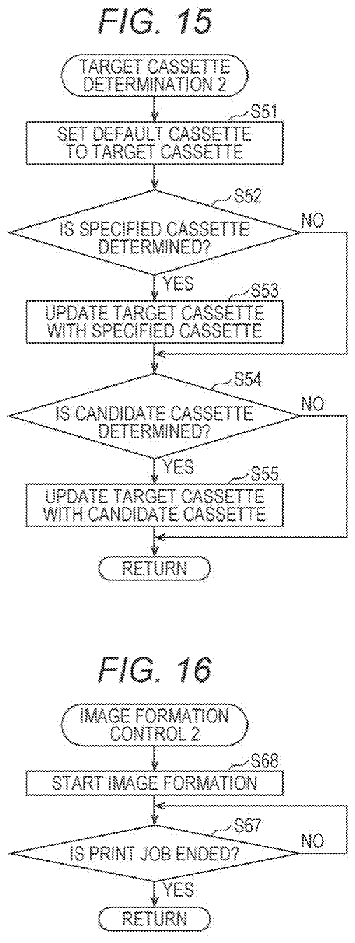

FIG. 15 is a flowchart illustrating an example of flow of a target cassette determination processing according to the second embodiment. The target cassette determination processing of the second embodiment is processing executed in step S15A of the image formation processing according to the second embodiment. A difference from the target cassette determination processing according to the first embodiment illustrated in FIG. 11 is that steps S56 to S58 are eliminated. The other processing is the same as the processing illustrated in FIG. 11 and will not be elaborated here.

FIG. 16 is a flowchart illustrating an example of flow of an image formation control processing according to the second embodiment. The image formation control processing according to the second embodiment is processing executed in step S17A of the image formation processing according to the second embodiment. A difference from the image formation control processing according to the first embodiment illustrated in FIG. 12 is that steps S61 to S66 are eliminated. The other processing is the same as the processing illustrated in FIG. 12 and will not be elaborated here.

As described above, the MFP 100 according to the second embodiment refers to the job priority table or the user priority table, determines the cassette that contains the paper of the medium type having the highest priority as the candidate cassette from among the three paper feed cassettes 151, 152, 153 and the manual insertion cassette 154, and forms an image on the paper contained in the candidate cassette. Therefore, an image is formed on the preset paper of the medium type having the priority. Therefore, it is not necessary for the user to select the paper and it is possible to facilitate the setting operation.

In addition, the job priority table associates priority with a plurality of medium types of paper for each of the plurality of job types and determines the priority associated with the job type of the accepted job. Therefore, it is possible to form an image on the paper of medium type suitable for the job.

In addition, the user priority table associates priority with a plurality of medium types of paper for each of the plurality of users and determines the priority associated with the user who has given an instruction of executing the accepted job. Therefore, it is possible to form an image on the paper of medium type suitable for the user.

In addition, the MFP 100 forms an image on the paper under the image formation condition specified with respect to the medium type of paper. Therefore, it is possible to form an image with appropriate image quality with respect to the medium type.

In addition, the MFP 100 forms an image on the paper under the image formation condition specified on the basis of the size of paper. Therefore, it is possible to form an image appropriate for the size of paper.

Although embodiments of the present invention have been described and illustrated in detail, the disclosed embodiments are made for purposes of illustration and example only and not limitation. The scope of the present invention should be interpreted by terms of the appended claims, and it is intended that meanings equivalent to the claims and all changes within the scope are included.

What is claimed is:

1. An image formation device comprising:
a plurality of containers that contains a recording medium;
an image former that forms an image on the recording medium; and
a hardware processor that determines the container that contains the recording medium on which an image is formed by the image former as a target container from among the plurality of containers, wherein
the hardware processor determines a priority container that finally contains a recording medium among the plurality of containers as the target container.

2. The image formation device according to claim 1, wherein the hardware processor, before an execution instruction operation causing the image former to form an image is detected as a user operation input by a user, when a containing operation of containing the recording medium in any of the plurality of containers is detected as the user operation, determines the container for which the containing operation is detected among the plurality of containers as the priority container.

3. The image formation device according to claim 2, wherein the hardware processor does not determine the priority container when a time in which the user operation is not detected is equal to or more than a predetermined time.

4. The image formation device according to claim 1, wherein the hardware processor, when a containing operation of containing the recording medium in any of the plurality of containers is detected in a period of time from when log in of a user is detected to when log out is detected, determines the container for which the containing operation is detected among the plurality of containers as the priority container.

5. The image formation device according to claim 4, wherein the hardware processor does not determine the priority container when the predetermined time elapses from detection of the containing operation.

6. The image formation device according to claim 2, wherein the hardware processor detects the containing operation when detecting opening and closing of any of the plurality of containers.

7. The image formation device according to claim 1, further comprising:
a conveyer that conveys the recording medium contained in the target container along a conveyance path; and
a medium detector that detects a medium type of the recording medium conveyed along the conveyance path, wherein
the hardware processor determines the medium type detected by the medium detector as a medium type of the recording medium contained in the priority container when the medium detector detects the medium type of the recording medium conveyed from the priority container by the conveyer.

8. The image formation device according to claim 7, wherein
the hardware processor associates each of the plurality of containers with the medium type of the recording medium contained in the container, and
the hardware processor associates the medium type detected by the medium detector with the priority container when the medium detector detects the medium type of the recording medium conveyed from the priority container by the conveyer.

9. The image formation device according to claim 1, wherein
the hardware processor associates each of the plurality of containers with the medium type of the recording medium contained in the container,
the hardware processor determines the container associated with a medium type having a highest priority among the plurality of container as a candidate container according to priority preset with respect to a plurality of medium types of a recording medium, and
the hardware processor determines the candidate container as the target container when the priority container is not determined and determines the priority container as the target container when the priority container is determined.

10. An image formation device comprising:
a plurality of containers that contains a recording medium;
a hardware processor that:
associates a medium type of the recording medium with the container with respect to each of the plurality of containers; and
determines the container associated with a medium type having a highest priority among the plurality of containers as a candidate container according to priority preset with respect to a plurality of medium types of a recording medium; and
an image former that forms an image on the recording medium contained in the candidate container.

11. The image formation device according to claim 9, further comprising:
a job accepter that accepts a job, wherein
the hardware processor associates priority with a plurality of medium types of the recording medium for each of a plurality of job types indicating a type of job that specifies an operation of forming an image by the image former, and
the hardware processor determines the job type of the job accepted by the job accepter and the priority associated by the hardware processor.

12. The image formation device according to claim 9, further comprising:
a job accepter that accepts a job, wherein
the hardware processor associates the priority with a plurality of medium types of the recording medium for each of a plurality of users, and
the hardware processor determines a user who has given an instruction of executing the job accepted by the job accepter and the priority associated by the hardware processor.

13. The image formation device according to claim 1, wherein the hardware processor causes the image former to form an image under an image formation condition specified with respect to the medium type of the recording medium on which an image is formed by the image former.

14. The image formation device according to claim 13, wherein
the hardware processor detects a size of the recording medium contained in the plurality of containers, and
the hardware processor determines an image formation condition on the basis of the size of the recording medium on which an image is formed by the image former.

15. An image formation method executed by an image formation device comprising:
a plurality of containers that contains a recording medium; and
an image former that forms an image on the recording medium,
the method comprising:
determining the container that contains the recording medium on which an image is formed by the image former as a target container from among the plurality of containers, wherein
the determining the container includes determining a priority container that finally contains the recording medium among the plurality of containers as the target container.

16. An image formation method executed by an image formation device comprising:
a plurality of containers that contains a recording medium; and
an image former that forms an image on the recording medium,
the method comprising:
associating a medium type of the recording medium with the container with respect to each of the plurality of containers;
determining the container associated with a medium type having a highest priority among the plurality of containers as a candidate container according to priority preset with respect to a plurality of medium types of a recording medium; and
controlling the image former to form an image on the recording medium contained in the candidate container.

17. A non-transitory recording medium storing a computer readable image formation program that controls an image formation device comprising:
a plurality of containers that contains a recording medium; and
an image former that forms an image on the recording medium, wherein
the program causes the computer to perform:
determining the container that contains the recording medium on which an image is formed by the image former as a target container from among the plurality of containers, and
the determining the container includes determining a priority container that finally contains the recording medium among the plurality of containers as the target container.

18. A non-transitory recording medium storing a computer readable image formation program that controls an image formation device comprising:
a plurality of containers that contains a recording medium; and
an image former that forms an image on the recording medium, wherein
the program causes the computer to perform:
associating a medium type of the recording medium with the container with respect to each of the plurality of containers;
determining the container associated with a medium type having a highest priority among the plurality of containers as a candidate container according to priority preset with respect to a plurality of medium types of a recording medium; and
controlling the image former to form an image on the recording medium contained in the candidate container.

19. The image formation device according to claim 10, wherein the hardware processor causes the image former to form an image under an image formation condition specified with respect to the medium type of the recording medium on which an image is formed by the image former.
